(19) United States
(12) Patent Application Publication
(10) Pub. No.: US 2014/0136079 A1
(43) Pub. Date: May 15, 2014

(54) Control Strategy In Gaseous Fuel Internal Combustion Engine

(71) Applicants: Arvind Sivasubramanian, (US); Travis Barnes, (US); Christopher F. Gallmeyer, (US); David James Lin, (US)

(72) Inventors: Arvind Sivasubramanian, (US); Travis Barnes, (US); Christopher F. Gallmeyer, (US); David James Lin, (US)

(73) Assignee: CATERPILLAR INC., Peoria, IL (US)

(21) Appl. No.: 13/677,429

(22) Filed: Nov. 15, 2012

(51) Int. Cl. F02D 41/26

(52) U.S. Cl. CPC F02D 41/26
USPC 701/103

(57) ABSTRACT

Controlling a gaseous fuel internal combustion engine includes receiving a signal indicative of a desired state of an operating parameter of the engine dependent upon a fueling rate, and tracking the desired state via adjusting a pressure drop from a gaseous fuel common rail to an intake conduit such that the fueling rate is adjusted toward a fueling accordant with the desired state. The control further includes limiting an error in the tracking via executing the adjustment of the pressure drop responsive to a fluid pressure disturbance within the intake conduit.

### TECHNICAL FIELD

The present disclosure relates generally to controlling a gaseous fuel internal combustion engine, and relates more particularly to limiting an error in tracking a desired state of an operating parameter of the engine dependent upon a fueling rate.

### BACKGROUND

Gaseous fuel internal combustion engines are well known and widely used. Example applications include powering mobile machinery, electrical power generation, and driving pumps, compressors and the like. In recent years, gaseous fuel internal combustion engines have seen increasing application in environments where a supply of combustible gaseous fuel is readily available on-site, whereas conventional liquid fuels are more expensive or generally unavailable. Natural gas fields, pipeline stations and landfills are notable among such environments.

Many of the operating characteristics of gaseous fuel engines find analogy in liquid fuel engines. In general terms, a gaseous fuel is delivered to a combustion cylinder of the engine where it is ignited, commonly via a sparkplug or combustion of a pilot fuel, to combust with air and thus drive motion of a piston to rotate an engine crankshaft, in much the same way that liquid fuel engines operate. All things being equal, an amount of the gaseous fuel combusted in each engine cycle determines a power output and often a speed of rotation of the engine.

In one class of gaseous fuel internal combustion engines, the amount of fuel combusted per engine cycle is determined by injecting the gaseous fuel directly into the combustion cylinders, or into an intake conduit upstream, similar to the manner in which fuel injected liquid fuel engines work. In another class of gaseous fuel engines, rather than attempting to inject a measured quantity of gaseous fuel, the fuel is supplied to an intake conduit of the engine at a pressure greater than an intake air pressure, and enters the intake conduit by way of an admission valve. In both general types of systems, a common rail may be employed which contains the gaseous fuel at some pressure and feeds the gaseous fuel injectors or admission valves, as the case may be. The operating characteristics of these two general engine types may nevertheless be different, as are the problems likely encountered by engineers seeking to improve or tailor the functioning of such engines to various ends such as an emissions profile. U.S. Pat. No. 6,226,981 to Bruch et al. is directed to an air to fuel ratio control for gas engine and method of operation. In Bruch et al., a fuel system has exhaust gas monitors for signals related to exhaust gas mass flow, and an air to fuel controller that apparently adjusts the intake of gaseous fuel to maintain a desired level of exhaust gas mass flow. Bruch et al. note that variation in fuel composition may result in undesirably high emissions of certain types.

### SUMMARY

In one aspect, a method of controlling a gaseous fuel internal combustion engine is provided, where a fueling rate is determined by a pressure drop from a gaseous fuel common rail to an intake conduit configured to convey a mixture of gaseous fuel and air to a plurality of combustion cylinders in the engine. The method includes receiving a signal indicative of a desired state of an operating parameter of the engine dependent upon the fueling rate, and tracking the desired state at least in part by adjusting the pressure drop such that the fueling rate is adjusted toward a fueling rate accordant a with desired state. The method further includes limiting an error in the tracking at least in part by executing the adjustment of the pressure drop responsive to a disturbance to a fluid pressure within the intake conduit.

In another aspect, a gaseous fuel internal combustion engine system includes an engine having an engine housing and an intake conduit configured to convey a mixture of air and gaseous fuel to a plurality of cylinders formed in the engine housing. The engine further includes a common rail configured to deliver the gaseous fuel to the intake conduit at a fueling rate dependent upon a pressure drop from the common rail to the intake conduit, and a pressure control mechanism for the common rail. The engine system further includes an electronic controller configured to receive a signal indicative of a desired state of an operating parameter of the engine dependent upon the fueling rate. The electronic controller is in control communication with the pressure control mechanism, and configured to track the desired state of the operating parameter at least in part by adjusting the pressure drop via a control command to the pressure control mechanism, such that the fueling rate is adjusted toward a fueling rate accordant with the desired state. The electronic controller is further configured to limit an error in the tracking at least in part by determining the control command responsive to a disturbance to a fluid pressure within the intake conduit.

In still another aspect, an engine control system for a gaseous fuel internal combustion engine includes a pressure control mechanism configured to control a pressure of gaseous fuel within a common rail configured to deliver the gaseous fuel to an intake conduit of the engine at a fueling rate dependent upon a pressure drop from the common rail to the intake conduit. The control system further includes an electronic controller configured to receive a signal indicative of a desired state of an operating parameter of the engine dependent upon the fueling rate. The electronic controller is in control communication with the pressure control mechanism, and configured to track the desired state of the operating parameter at least in part by adjusting the pressure drop via a control command to the pressure control mechanism, such that the fueling rate is adjusted toward a fueling rate accordant with the desired state. The electronic controller is further configured to limit an error in the tracking at least in part by determining the control command responsive to a disturbance to a fluid pressure within the intake conduit.

### BRIEF DESCRIPTION OF THE DRAWINGS

FIG. 1 is a schematic view of an engine system according to one embodiment;

FIG. 2 is a block diagram of a control strategy according to one embodiment;

FIG. 3 is a plurality of graphs of engine operating parameters over time; and

FIG. 4 is another plurality of graphs showing engine operating parameters over time.

### DETAILED DESCRIPTION

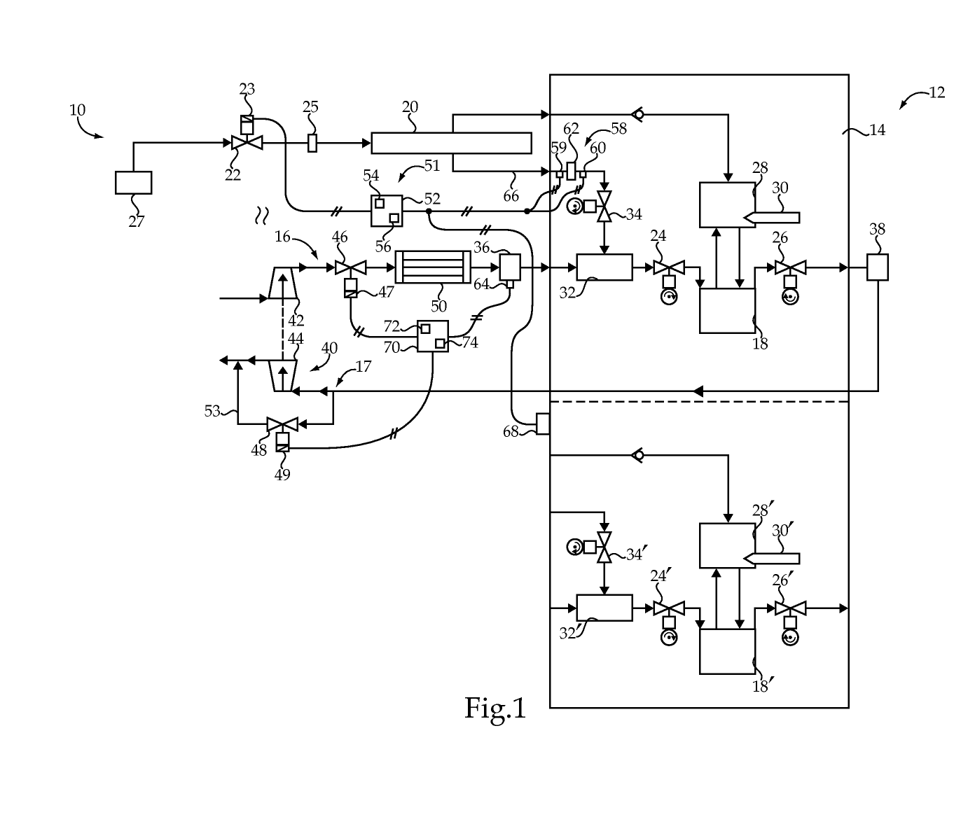

Referring to FIG. 1, there is shown a gaseous fuel internal combustion engine system 10 according to one embodiment. System 10 includes an engine 12 having an engine housing 14, an intake conduit 16 configured to convey a mixture of air and gaseous fuel to a plurality of cylinders formed in engine housing 14, and an exhaust conduit 17. Engine 12 may include any number of cylinders, and in the illustrated embodiment includes a first cylinder 18 and a second cylinder 18′. Numbers shown with a prime represent features associated with cylinder 18′ and having structures and functions similar or identical to features identified via unprimed reference numerals and more specifically discussed herein. Engine 12 further includes a common rail 20 configured to deliver the gaseous fuel to intake conduit 16 at a fueling rate dependent upon a pressure drop from common rail 20 to intake conduit 16, and a pressure control mechanism 22 for common rail 20. In a practical implementation strategy, pressure control mechanism 22 includes a valve controlled via an electrical actuator 23 to control fluid communications between common rail 20 and a supply of gaseous fuel 27. In certain embodiments, supply 27 could contain gaseous fuel at a relatively low pressure, which is increased via a pressure control mechanism for supplying to common rail 20. In a practical implementation strategy, supply 27 may contain or convey gaseous fuel at a relatively high pressure which is throttled down via mechanism 22 for supplying to common rail 20. Supply 27 might include a gaseous fuel supply at a wellhead, or a pipeline conduit conveying pressurized gaseous or liquefied gaseous fuel. A venturi 25 may be situated between mechanism 22 and common rail 20. Those skilled in the art will appreciate that a variety of other subsystems and components such as a pump, a mechanism for enabling the expansion of liquefied gaseous fuel to a gaseous form, and still others might be employed to supply common rail 20 with a gaseous fuel such as natural gas, propane, landfill gas, or any other suitable combustible gaseous fuel. In any event, pressure control mechanism 22 will be configured to enable the control of a pressure in common rail 20, such that the pressure drop noted above from common rail 20 to intake conduit 16 can be controlled for purposes which will be apparent from the following description.

Engine 12 may further include an intake valve 24 configured to connect intake conduit 16 with cylinder 18, and an exhaust valve 26 configured to connect cylinder 18 with an exhaust manifold 38. Each of intake valve 24 and exhaust valve 26 may be cam-actuated in a practical implementation strategy. Engine 12 may further include a pre-combustion chamber 28 formed in engine housing 14 and having a sparkplug 30 positioned at least partially therein. Pre-combustion chamber 28 may receive gaseous fuel from common rail 20, which is spark-ignited to subsequently ignite a main charge of gaseous fuel and air within cylinder 18.

As noted above, intake conduit 16 conveys a mixture of air and gaseous fuel to cylinder 18 and such other cylinders as might be formed in engine housing 14, which mixture is ignited via one of the plurality of sparkplugs associated with each of a plurality of pre-combustion chambers. As also noted above, a fueling rate of engine 12 may depend upon a pressure drop from common rail 20 to intake conduit 16. In one embodiment, the gaseous fuel from common rail 20 may pass through a flow restriction orifice 62, thenceforth to an inlet port 37 in intake conduit 16, by way of an admission valve 34, which may also be cam-actuated.

Engine system 10 may further include a turbocharger 40 having a compressor 42 within intake conduit 16, and a turbine 44 within exhaust conduit 17. An after-cooler 50 may be positioned fluidly between compressor 42 and an intake manifold 36. Engine system 10 may further include a flow control element positioned within intake conduit 16, exhaust conduit 17, or both. To this end, engine 12 may further include a choke 46, such as a conventional butterfly valve choke, positioned within intake conduit 16 and having an electrical choke actuator 47 operably coupled therewith. Engine 12 may also include a waste gate 48 within a bypass conduit 53 enabling exhaust gases to bypass turbine 44, and having an electrical waste gate actuator 49 coupled therewith. Choke 46 and waste gate 48 can be operated to control an air to fuel ratio in engine system 10 in a manner that will be familiar to those skilled in the art.

It has been discovered that control of air to fuel ratio, such as by way of controlling choke 46 or waste gate 48 or both can induce disturbances in fluid pressure within intake conduit 16. It will be recalled that a fueling rate in engine system 10 is dependent upon a pressure drop from common rail 20 to intake conduit 16. Accordingly, disturbances in fluid pressure within intake conduit 16 could theoretically disturb the fueling rate in engine system 10, in turn affecting the state of one or more operating parameters of engine 10 which are dependent upon the fueling rate. In one embodiment an operating parameter of interest dependent upon the fueling rate which could be perturbed by disturbances in fluid pressure within intake conduit 16 is engine speed. In other instances, an operating parameter so perturbed might be engine output torque. Unless some compensation for the disturbances to fluid pressure within intake conduit 16 is performed, then errors in the operating parameters dependent upon fueling rate can be induced or increased. As will be further apparent from the following description, the present disclosure contemplates a control strategy and control logic which enable tracking a desired state of an operating parameter dependent upon fueling rate in a manner that is decoupled from fluid pressure disturbances within intake conduit 16.

To this end, engine system 10 further includes a control system 51 having an electronic controller 52 including a computer readable memory 54 and a data processor 56. Computer readable memory 54, which may include any suitable volatile or non-volatile memory, stores computer executable program instructions for tracking a desired state of an operating parameter such as engine speed or engine output torque which is dependent upon fueling rate. Data processor 56 is in control communication with mechanism 22 and configured via executing the instructions to track a desired state of the operating parameter at least in part by adjusting the pressure drop from common rail 20 to intake conduit 16. In a practical implementation strategy, electronic controller 52 receives a signal indicative of a desired state of the operating parameter dependent upon fueling rate, and tracks the desired state via outputting a control command to pressure control mechanism 22, such that the fueling rate is adjusted toward a fueling rate accordant with the desired state. As used herein, the term “accordant” should be understood to mean a fueling rate which can be expected at least under controlled conditions to impart the desired state of the operating parameter. For instance, a fueling rate of “x” grams per minute would be accordant with an engine speed of “y” rpm or engine output torque of “z” newton meters. Electronic controller 52 may be further configured to limit an error in the tracking at least in part by determining the control command to be sent to pressure control mechanism 22 responsive to a disturbance to a fluid pressure within intake conduit 16. Another way to understand this capability is that electronic controller 52 can execute an adjustment of the pressure drop from common rail 20 to intake conduit 16 responsive to a disturbance to fluid pressure within intake conduit 16. Such capabilities of engine system 10 will be further understood by way of the subsequent description herein of example operation and engine control.

It will be recalled that choke 46 and/or waste gate 48 may be used to control fluid pressure within intake conduit 16. When choke 46 is wide open, generally a full available pressure of air from compressor 42 is supplied to intake manifold 36. When choke 46 is closed as much as possible, the pressure of intake air supplied to intake manifold 36 will be lower. In the case of waste gate 48, those skilled in the art will appreciate that opening or closing waste gate 48 can vary an amount of exhaust energy applied to turbine 44, and thus affect the speed of rotation of compressor 42, hence also affecting intake air pressure. The control of fluid pressure in intake conduit 16, for purposes of controlling air to fuel ratio or for any other purpose, may be performed by a separate electronic controller 70. Electronic controller 70, which could be understood as or part of a separate air to fuel ratio control system in certain embodiments, includes a computer readable memory 72 and a data processor 74. Processor 74 may be configured to execute computer readable instructions stored on memory 72 to maintain or adjust an air to fuel ratio in engine system 10. In a practical implementation strategy, electronic controller 70 may be in control communication with choke actuator 47 and waste gate actuator 49 to perform appropriate adjustments to choke 46 and actuator 48 to maintain or adjust intake manifold pressure to obtain a desired lean ratio of air to gaseous fuel. Electronic controller 70 may receive data indicative of intake manifold pressure from an intake manifold pressure sensor 64, and can perform this control in a closed loop fashion.

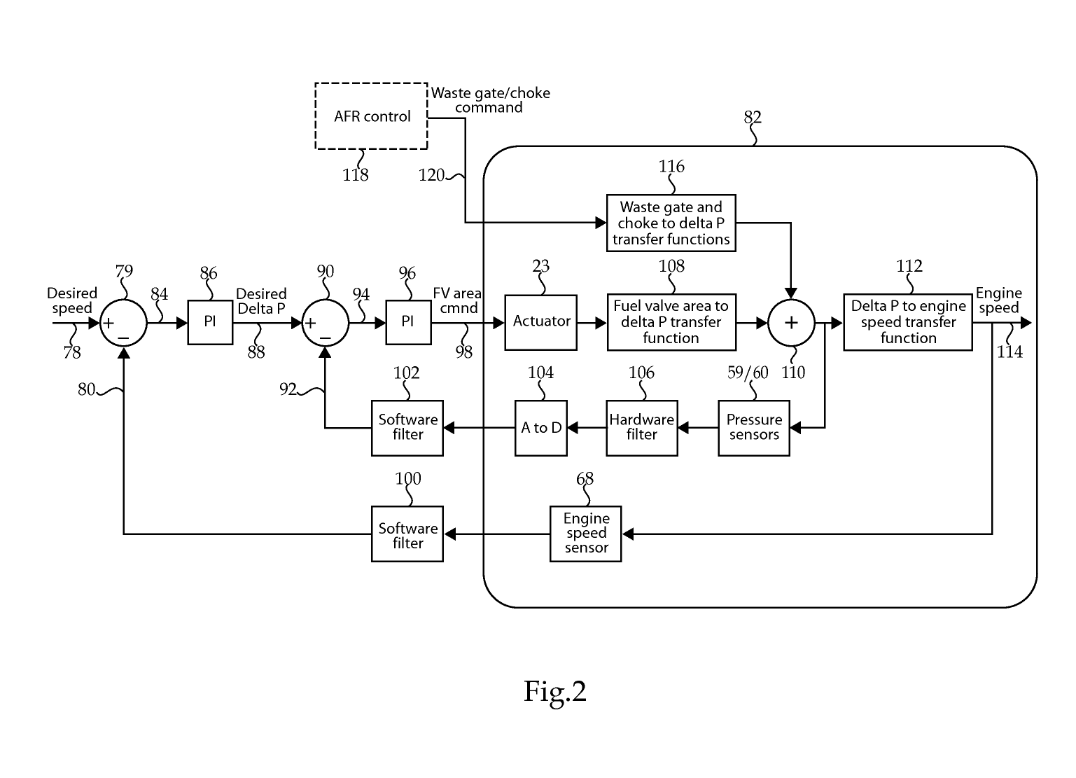

Referring also now to FIG. 2, there is shown a block diagram 76 further illustrating an example control strategy according to the present disclosure. Air/fuel ratio control is shown at block 118, and a waste gate and/or choke command 120 is outputted from block 118. In FIG. 2 the plant is shown via reference numeral 82, and includes waste gate and choke to ΔP transfer functions, a fuel valve area to ΔP transfer function in block 108, and a ΔP to engine speed transfer function in block 112. Resultant engine speed is shown via reference numeral 114. Block 110 represents ΔP as modified, in other words disturbed, by the action of AFR control block 118. Actuator 23 is represented at block 23.

It will be recalled that the pressure drop from common rail 20 to intake conduit 16 may be a pressure drop across orifice 62, and to this end electronic controller 52 may monitor the pressure drop, or ΔP as mentioned above, via a sensing mechanism 58 including at least one sensor exposed to a fluid pressure of a fuel supply conduit 66 upstream of orifice 62 and a fluid pressure downstream of orifice 62. In a practical implementation strategy, an upstream pressure sensor 59 and a downstream pressure sensor 60 may be used. Pressure sensors 59 and 60 are also shown in a control block in plant 82. Output of pressure sensors 59 and 60 may be processed via a hardware filter in block 106 and an analog to digital converter in block 104. Control system 51 may also include an engine speed sensor 68 shown in plant 82 and also in FIG. 1, and sensing engine speed 114. An output of engine speed sensor 68, in other words a measured engine speed, may be processed via a software filter 100 to produce a measured engine speed signal 80. In general terms, electronic controller 52 may track a desired engine speed responsive to a desired engine speed signal 78 and measured engine speed signal 80. In particular, at block 79 an engine speed error signal 84 may be generated, based on a difference between signals 78 and 80. The engine speed error signal 84 may be received in a proportional control block 86, for instance, employing a proportional integral (PI) controller. At block 86, electronic controller 52 may be understood as calculating or otherwise determining a desired ΔP, which is output as a desired ΔP signal 88. At control block 90, electronic controller 52 may determine a ΔP error 94 responsive to a difference between desired ΔP signal 88 and measured ΔP signal 92. At control block 96 another proportional controller, such as another PI controller, can calculate a command 98 for actuator 23. Command 98 may be a commanded flow area of valve 22, imparting a pressure to common rail 20 which is calculated or otherwise determined to impart a desired pressure drop from common rail 20 to intake conduit 16, or adjust the pressure drop toward the desired pressure drop, to in turn adjust fueling rate toward a fueling rate accordant with desired engine speed.

Another way to understand the control logic represented in FIG. 2 is that electronic controller 52 is tracking desired engine speed in a closed loop fashion, the engine speed tracking being an outer control loop. Electronic controller 52 will track the desired engine speed by calculating a desired pressure drop from common rail 20 to intake conduit 16 which imparts a desired fueling rate, and commands an adjustment to valve 22 to ultimately obtain or approach the desired engine speed. Meanwhile, AFR control 118 is independently varying a fluid pressure within intake conduit 16. This action by AFR control 118 can cause disturbances to ΔP as represented by block 110. Electronic controller 52 may further be understood as tracking the desired ΔP in an inner loop. Tracking the desired ΔP in the inner loop compensates for disturbances in the ΔP induced by the action of AFR control 118. Still further understanding may be gained by considering how engine speed control, or control of another parameter dependent upon fueling rate, might proceed if the inner loop control were not employed. In such a scenario, a controller might attempt to vary a position of a pressure control mechanism for a common rail without information as to relatively rapidly changing or fluctuating pressures within an intake conduit. In such a case, it is likely that the fueling rate could not be adjusted to successfully track engine speed much of the time. For example, where seeking to increase fueling rate to increase engine speed in response to a negative engine speed error, one can imagine instances where ΔP would be adjusted by the AFR control and have the result of actually decreasing fueling rate, giving the opposite result of what is desired. In other words, the AFR control might cause a spike in intake pressure which would in turn reduce ΔP where the controller was attempting to actually increase ΔP. The present disclosure prevents the interaction of these loops, AFR control and engine speed control, such that errors in tracking engine speed are limited.

### INDUSTRIAL APPLICABILITY

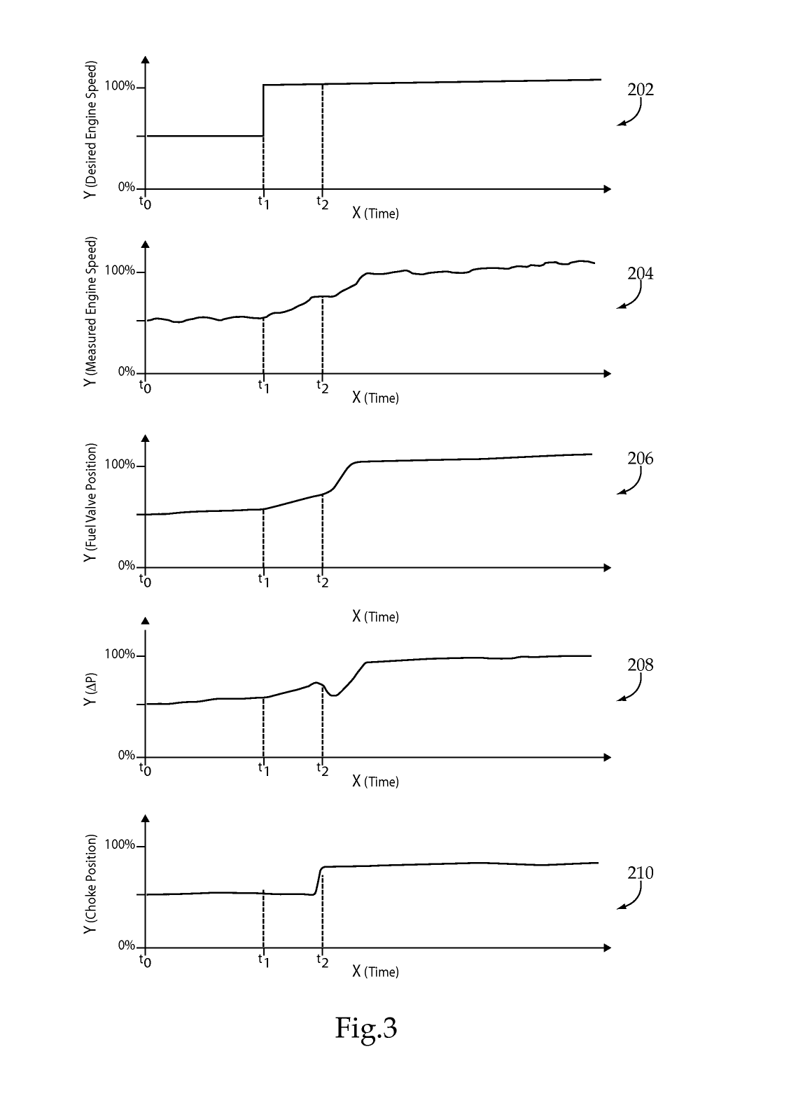

Referring now to FIG. 3, there are shown several graphs representing the state of various parameters of engine system 10 as they might appear during example control according to the present disclosure. In the first graph 202, there is shown a desired engine speed signal. The desired engine speed is substantially constant from a time t₀ to a time t₁. At time t₁, a step increase in desired engine speed occurs. In a second graph 104, there is shown measured engine speed over time. It may be noted that measured engine speed is relatively constant from time t₀ to time t₁, begins to increase from time t₁ to time t₂ and continues to increase beyond time t₂ toward a 100% measured engine speed, approximately as requested. In a third graph 206, there is shown fuel valve position over time. Fuel valve position is relatively constant from time t₀ to time t₁, increases from time t₁ to time t₂, and continues to increase, initially at the same rate of increase as that from time t₁ to time t₂, but then at a greater rate of increase, the significance of which will be apparent from the following description.

In a fourth graph 208, there is shown ΔP over time. From time t₀ to time t₁ ΔP is relatively constant. From time t₁ time t₂, ΔP increases then sharply decreases at time t₂ before bottoming out and beginning to increase again thereafter. In a fifth graph 210, there is shown choke position over time. Choke position is relatively constant from time t₀ to time t₁, and also relatively constant from time t₁ to time t₂. At time t₂, choke position begins to relatively sharply increase.

The increase in choke position shown at approximately time t₂ will tend to cause a disturbance to fluid pressure within intake conduit 16 as discussed herein. Choke 46 might be opened to increase a fluid pressure within intake conduit 16 and thus intake manifold 36, for purposes of air/fuel ratio control. As a result, the drop in ΔP seen at about t₂ in graph 208 represents a decreased difference between a pressure of common rail 20 and intake conduit 16 which could be expected to result from the increased fluid pressure.

Electronic controller 52 may meanwhile be tracking desired engine speed. Since an increase in desired engine speed has occurred at time t₁, electronic controller 52 may be gradually changing a position of pressure control mechanism/fuel valve 22, for example, to increase a flow area through mechanism 22 and obtain an increased fueling rate accordant with the increased desired engine speed. Electronic controller 52 is also, however, tracking desired ΔP such that commands to valve 22 are responsive to a difference between desired and measured ΔP. This can been seen in the increased rate of change in fuel valve positioning following time t₂. In FIG. 3, graph 210 depicts choke position. Since fluid pressure within intake conduit 16 can be dependent upon choke position, as well as waste gate position, it can be appreciated that similar or analogous phenomena could be observed where waste gate position is changed, or perhaps even another type of flow control element such as a variable geometry turbine. By comparing measured and desired pressure drops, ΔP, electronic controller 52 can compensate for the changed choke position and its resultant effects on fluid pressure in intake conduit 16, such that little or no change in fueling rate and thus engine speed is induced by a disturbance to fluid pressure within intake conduit 16.

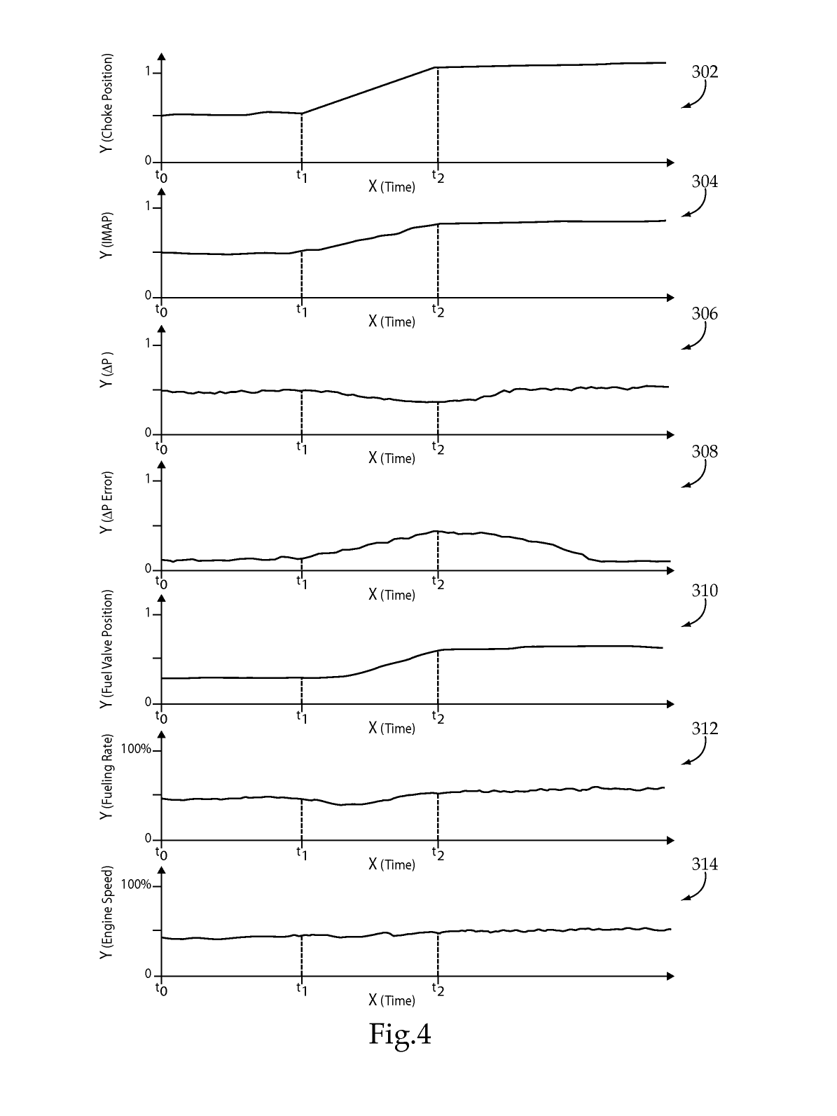

Referring now to FIG. 4, there is shown another group of graphs illustrating various engine operating parameters over time, in accordance with the present disclosure. In the FIG. 3 graphs a requested change in engine speed was illustrated. In the FIG. 4 graphs, it may be assumed that desired engine speed is constant. In a first graph 302 choke position is shown at times t₀, t₁, and t₂. In a second graph 304 intake manifold pressure is shown at times t₀, t₁, and t₂. A third graph 306 shows ΔP at times t₀, t₁, and t₂, and a fourth graph 308 shows a ΔP error at those same times. A fifth graph 310 shows fuel valve position, a sixth graph 312 shows fueling rate, and a seventh graph 314 shows engine speed, all at times t₀, t₁, and t₂.

In FIG. 4, choke position increases or opens from time t₁ to time t₂, and a corresponding increase in intake manifold pressure is observed. As can be seen from graphs 306 and 308, ΔP decreases from time t₁ to time t₂, and ΔP error increases. Shortly after time t₁, fuel valve position begins to change, in other words increase in flow area to increase fuel pressure in common rail 20 and restore ΔP to a value accordant with desired engine speed. It may be noted that fueling rate exhibits a modest drop beginning shortly after time t₁, but then recovers as time t₂ approaches as shown in graph 312. Engine speed, however, exhibits very little or zero drop from time t₁ to time t₂. From the graphs of FIG. 4, it will thus be apparent that a response time and response severity in engine speed to adjustments in the fueling rate may be relatively slower, and a response time of ΔP to disturbances in fluid pressure within intake conduit 16 may be relatively faster. In other words, ΔP begins to change almost instantaneously upon the change in choke position beginning at time t₂. Engine speed, on the other hand, exhibits no instability or change from time t₁ to time t₂. Another way to understand this principle is that it takes engine 12 a little bit of time to slow down, or speed up, but that the fluid pressure change in intake conduit 16 can change ΔP almost instantaneously. It is at least in part this difference in response time and severity, and the manner in which it is recognized and exploited by way of the present control strategy, that decouples tracking of desired engine speed from fluid pressure disturbances in intake conduit induced by control of air to fuel ratio.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A method of controlling a gaseous fuel internal combustion engine where a fueling rate is determined by a pressure drop from a gaseous fuel common rail to an intake conduit configured to convey a mixture of gaseous fuel and air to a plurality of combustion cylinders in the engine, the method comprising the steps of:
receiving a signal indicative of a desired state of an operating parameter of the engine dependent upon the fueling rate;
tracking the desired state of the operating parameter at least in part by adjusting the pressure drop such that the fueling rate is adjusted toward a fueling rate accordant with the desired state; and
limiting an error in the tracking at least in part by executing the adjustment of the pressure drop responsive to a disturbance to a fluid pressure within the intake conduit.

2. The method of claim 1 wherein the operating parameter includes engine speed.

3. The method of claim 2 wherein the step of limiting further includes decoupling the tracking from the fluid pressure disturbance within the intake conduit.

4. The method of claim 2 wherein the step of limiting further includes executing the adjustment responsive to a disturbance induced by a commanded change in a position of a flow control mechanism within the intake conduit or an exhaust conduit of the engine.

5. The method of claim 4 wherein the commanded change is based on a difference between a desired ratio of air to gaseous fuel in the engine, and a measured ratio.

6. The method of claim 2 wherein the pressure drop includes a pressure drop across a flow restriction orifice in a fuel supply conduit connecting the gaseous fuel common rail to the intake conduit, and further comprising a step of determining a desired pressure drop across the orifice responsive to a difference between the desired state and a measured state of the operating parameter.

7. The method of claim 6 further comprising the steps of receiving a second signal indicative of a measured pressure drop from the gaseous fuel common rail to the intake conduit, and comparing the measured and desired pressure drops.

8. The method of claim 7 wherein the step of limiting further includes executing the adjustment via outputting a control command to a pressure control mechanism for the common rail responsive to the comparison of the measured and desired pressure drops.

9. A gaseous fuel internal combustion engine system comprising:
an engine including an engine housing and an intake conduit configured to convey a mixture of air and gaseous fuel to a plurality of cylinders formed in the engine housing, the engine further including a common rail configured to deliver the gaseous fuel to the intake conduit at a fueling rate dependent upon a pressure drop from the common rail to the intake conduit, and a pressure control mechanism for the common rail;
an electronic controller configured to receive a signal indicative of a desired state of an operating parameter of the engine dependent upon the fueling rate;
the electronic controller being in control communication with the pressure control mechanism, and configured to track the desired state of the operating parameter at least in part by adjusting the pressure drop via a control command to the pressure control mechanism, such that the fueling rate is adjusted toward a fueling rate accordant with the desired state; and
the electronic controller being further configured to limit an error in the tracking at least in part by determining the control command responsive to a disturbance to a fluid pressure within the intake conduit.

10. The engine system of claim 9 wherein the engine further includes a fuel supply conduit extending fluidly between the common rail and the intake conduit and having a flow restriction orifice therein, and a cam-operated admission valve positioned fluidly between the fuel supply conduit and the intake conduit, such that the pressure drop includes a pressure drop across the orifice.

11. The engine system of claim 10 wherein the engine is a lean burn engine having a plurality of spark plugs each positioned at least partially within a different one of the plurality of cylinders.

12. The engine system of claim 10 wherein the operating parameter includes engine speed, and further comprising an engine speed sensing mechanism, and wherein the electronic controller is further configured to receive data from the engine speed sensing mechanism indicative of a desired engine speed and responsively determine a desired pressure drop across the orifice.

13. The engine system of claim 12 further comprising a second sensing mechanism including at least one sensor exposed to fluid pressures of the fuel supply conduit on upstream and downstream sides of the orifice.

14. The engine system of claim 13 wherein the electronic controller is further configured to receive data from the second sensing mechanism indicative of a measured pressure drop across the flow restriction orifice, and to determine the control command responsive to a difference between the measured and desired pressure drops.

15. The engine system of claim 10 wherein the engine further includes a flow control mechanism within the intake conduit or the exhaust conduit, and wherein the electronic controller is further configured to limit the error via determining the control command responsive to a disturbance induced by a change in a position of the flow control mechanism.

16. An engine control system for a gaseous fuel internal combustion engine comprising:
a pressure control mechanism configured to control a pressure of gaseous fuel within a common rail configured to deliver the gaseous fuel to an intake conduit of the engine at a fueling rate dependent upon a pressure drop from the common rail to the intake conduit;
an electronic controller configured to receive a signal indicative of a desired state of an operating parameter of the engine dependent upon the fueling rate;
the electronic controller being in control communication with the pressure control mechanism, and configured to track the desired state of the operating parameter at least in part by adjusting the pressure drop via a control command to the pressure control mechanism, such that the fueling rate is adjusted toward a fueling rate accordant with the desired state; and
the electronic controller being further configured to limit an error in the tracking at least in part by determining the control command responsive to a disturbance to a fluid pressure within the intake conduit.

17. The control system of claim 16 further comprising a flow control mechanism positionable within the intake conduit or an exhaust conduit of the engine, and a second electronic controller in control communication with the flow control mechanism and configured to induce the disturbance to the fluid pressure via varying a position of the flow control mechanism to control a ratio of air to gaseous fuel in the engine.

18. The control system of claim 17 wherein the operating parameter includes engine speed, and further comprising a first sensing mechanism in communication with the first electronic controller and configured to monitor the engine speed, and a second sensing mechanism also in communication with the first electronic controller and configured to monitor the pressure drop.

19. The control system of claim 18 wherein a response time of the engine speed to the adjustment in the fueling rate is relatively slower, and wherein a response time of the pressure drop to the disturbance is relatively faster, such that the first electronic controller is configured via the limitation of the error to decouple the fueling rate from the control of the ratio of air to gaseous fuel.
